(19) United States
(12) Patent Application Publication
(10) Pub. No.: US 2026/0276485 A1
(43) Pub. Date: Sep. 17, 2026

(54) CHEST MOTION EMULATOR

(71) Applicant: THE ALFRED E. MANN FOUNDATION FOR SCIENTIFIC RESEARCH, Valencia, CA (US)

(72) Inventors: Rankiri Tissa KARUNASIRI, Valencia, CA (US); Fernando ÁVILA, Castaic, CA (US)

(21) Appl. No.: 19/562,750

(22) Filed: Mar. 10, 2026

Related U.S. Application Data
(60) Provisional application No. 63/770,308, filed on Mar. 11, 2025.

(51) Int. Cl. G01M 99/00

(52) U.S. Cl. CPC G01M 99/00

(57) ABSTRACT

A chest motion emulator. In some embodiments, a system includes a chest motion emulator, including a first linear actuator, the first linear actuator being configured to support a device under test.

### CROSS-REFERENCE TO RELATED APPLICATION(S)

The present application claims priority to and the benefit of U.S. Provisional Application No. 63/770,308, filed Mar. 11, 2025, entitled “CHEST MOTION EMULATOR”, the entire content of which is incorporated herein by reference.

### FIELD

One or more aspects of embodiments according to the present disclosure relate to motion-sensing devices, and more particularly to a chest motion emulator for testing such devices.

### BACKGROUND

Various kinds of medical devices may monitor breathing and cardiac activity by monitoring the associated motions of the chest. Such devices may be tested during design, manufacturing, or service.

It is with respect to this general technical environment that aspects of the present disclosure are related.

### SUMMARY

According to an embodiment of the present disclosure, there is provided a system including: a chest motion emulator, including: a first linear actuator, the first linear actuator being configured to support a device under test.

In some embodiments, the first linear actuator includes a voice coil actuator.

In some embodiments, the first linear actuator includes a loudspeaker.

In some embodiments, the loudspeaker includes a cone including a mounting hole for securing the device under test.

In some embodiments, the chest motion emulator further includes a drive amplifier connected to the first linear actuator.

In some embodiments, the drive amplifier is DC-coupled.

In some embodiments, the drive amplifier is a class D amplifier.

In some embodiments, the combination of the drive amplifier and the first linear actuator has a passband including a frequency range extending from 1 Hz to 5 Hz.

In some embodiments, the combination of the drive amplifier and the first linear actuator has a passband including a frequency range extending from 0.1 Hz to 5 Hz.

In some embodiments, the system further includes a second linear actuator, wherein the first linear actuator and the second linear actuator are configured to produce motion, of the device under test, in a first degree of freedom and in a second degree of freedom.

In some embodiments, the first degree of freedom is a first translational degree of freedom and the second degree of freedom is a second translational degree of freedom, different from the first translational degree of freedom.

In some embodiments, the first degree of freedom is a translational degree of freedom and the second degree of freedom is a rotational degree of freedom.

In some embodiments: the chest motion emulator is capable of emulating chest motion of a subject, and the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

According to an embodiment of the present disclosure, there is provided a system including: a first loudspeaker; and a drive circuit, the drive circuit being configured to cause the first loudspeaker to move in a manner emulating chest motion of a subject.

In some embodiments, the first loudspeaker is configured to support a device under test.

In some embodiments, the first loudspeaker includes a cone having a flat portion suitable for supporting the device under test.

In some embodiments, the cone includes a mounting hole for securing the device under test.

In some embodiments, the drive circuit includes a drive amplifier connected to the first loudspeaker.

In some embodiments, the drive amplifier is DC-coupled.

In some embodiments, the drive amplifier is a class D amplifier.

In some embodiments, the combination of the drive amplifier and the first loudspeaker has a passband including a frequency range extending from 1 Hz to 5 Hz.

In some embodiments, the combination of the drive amplifier and the first loudspeaker has a passband including a frequency range extending from 0.1 Hz to 5 Hz.

In some embodiments, the system further includes a second loudspeaker, wherein the first loudspeaker and the second loudspeaker are configured to produce motion, of a device under test, in a first degree of freedom and in a second degree of freedom.

In some embodiments, the first degree of freedom is a first translational degree of freedom and the second degree of freedom is a second translational degree of freedom, different from the first translational degree of freedom.

In some embodiments, the first degree of freedom is a translational degree of freedom and the second degree of freedom is a rotational degree of freedom.

In some embodiments, the first loudspeaker is capable of emulating motion caused by breathing and motion caused by a heartbeat.

In some embodiments, the first loudspeaker is further capable of emulating noise motion.

In some embodiments, the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

In some embodiments, the drive circuit is capable of causing a voice coil of the first loudspeaker to move at least 5 mm at any frequency between 1 Hz and 5 Hz.

According to an embodiment of the present disclosure, there is provided a system including: a chest motion emulator, including: a first linear actuator, and a drive amplifier for driving the first linear actuator, the drive amplifier being direct-current coupled (DC-coupled).

In some embodiments, the first linear actuator includes a voice coil actuator.

In some embodiments, the first linear actuator includes a loudspeaker.

In some embodiments, the loudspeaker includes a cone including a mounting hole for securing a device under test.

In some embodiments, the drive amplifier is a class D amplifier.

In some embodiments, the combination of the drive amplifier and the first linear actuator has a passband including a frequency range extending from 1 Hz to 5 Hz.

In some embodiments, the combination of the drive amplifier and the first linear actuator has a passband including a frequency range extending from 0.1 Hz to 5 Hz.

In some embodiments, the system further includes a second linear actuator, wherein the first linear actuator and the second linear actuator are configured to produce motion, of a device under test, in a first degree of freedom and in a second degree of freedom.

In some embodiments, the first degree of freedom is a first translational degree of freedom and the second degree of freedom is a second translational degree of freedom, different from the first translational degree of freedom.

In some embodiments, the first degree of freedom is a translational degree of freedom and the second degree of freedom is a rotational degree of freedom.

In some embodiments: the chest motion emulator is capable of emulating chest motion, and the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

According to an embodiment of the present disclosure, there is provided a method, including: generating emulated motion, by a chest motion emulator, the emulated motion emulating chest motion of a subject, the chest motion emulator including: a loudspeaker; and a drive circuit.

In some embodiments, the chest motion includes motion caused by breathing.

In some embodiments, the chest motion further includes motion caused by a heartbeat.

In some embodiments, the chest motion further includes noise motion.

In some embodiments, the noise motion includes non-breathing skeletal muscle motion.

In some embodiments, the noise motion includes digestive motion.

In some embodiments, the generating of the motion includes: generating a target motion profile; generating a drive signal based on the target motion profile; and applying the drive signal to the loudspeaker.

In some embodiments, the generating of the target motion profile includes: generating a recorded chest motion signal by recording a signal from a motion sensor secured to the chest of a subject; and modifying the recorded chest motion signal.

### BRIEF DESCRIPTION OF THE DRAWINGS

These and other features and advantages of the present disclosure will be appreciated and understood with reference to the specification, claims, and appended drawings wherein:

FIG. 1A is a block diagram of a portion of a chest motion emulator, according to an embodiment of the present disclosure;

FIG. 1B is a schematic drawing of a portion of a chest motion emulator, according to an embodiment of the present disclosure;

FIG. 1C is a block diagram of a portion of a chest motion emulator, according to an embodiment of the present disclosure;

FIG. 2A is a perspective drawing of a portion of a chest motion emulator, according to an embodiment of the present disclosure;

FIG. 2B is a perspective drawing of a portion of a chest motion emulator, according to an embodiment of the present disclosure; and

FIG. 3 is a flow chart of a method for operating a chest motion emulator, according to an embodiment of the present disclosure.

### DETAILED DESCRIPTION

The detailed description set forth below in connection with the appended drawings is intended as a description of exemplary embodiments of a chest motion emulator and associated methods provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Embodiments described in this disclosure pertain to motion-sensing devices, specifically focusing on a chest motion emulator that is utilized for testing these devices. The chest motion emulator is designed to simulate physiological movements, allowing for comprehensive evaluation and characterization of motion-sensing devices under controlled conditions.

Medical devices having sensors for monitoring chest motion have various applications, including monitoring breathing or heartbeat. Such devices may include motion sensors, e.g., inertial sensors, such as gyroscopes, magnetometers, or accelerometers.

During the design, manufacturing, or servicing of such a device, it may be advantageous to test the operation and accuracy of the device. Such testing may be performed using a live test subject (e.g., a human subject) in a lab environment, but this method may be costly or impractical, e.g., during device development, when testing may be required for an extended period of time. It may also be advantageous, during development, to test the device with “corner cases” including uncommon scenarios (e.g., high heart rates), and such testing may be hazardous to a live test subject. As such a chest emulator capable of artificially reproducing various breathing patterns or heartbeat patterns (or motion simultaneously emulating breathing and heartbeat) may be useful, especially during device development.

In the context of implantable medical devices (IMDs) containing motion sensors, it may also be beneficial to test the functionality of motion sensors in the operating room or at a time just prior to surgical implantation, to confirm that motion sensors within the IMD were not damaged in transit from the manufacturer to the surgical theater.

One example of an IMD that may include motion sensors is an implantable pulse generator (IPG). IPGs are configured to deliver electrical stimulation to an anatomical target, such as a peripheral nerve, and may be utilized to treat a variety of medical conditions, depending on the nerve being stimulated. IPGs typically include a biocompatible case that houses stimulation circuitry, and an electrode lead (such as a nerve cuff) may be operably coupled to the stimulation circuitry to transmit electrical pulses from the circuitry to the nerve. Depending on the implementation, one or more motion sensors could be provided within or on the case, or a motion sensor could be carried by the electrode lead. In any case, such sensors may be used to monitor patient health, verify treatment efficacy, or to detect biomarkers, such as changes in heart rate or respiration. Detection of a biomarker may be used as a trigger to start, stop, or otherwise modulate a parameter of stimulation, in certain implementations. Accordingly, for at least some IPGs, motion sensors may be verified to function properly prior to device implantation.

As such, in some embodiments, a chest motion emulator is used to move a device under test (DUT) in a prescribed manner, so that the performance of the device under test may be assessed or characterized. In at least one implementation, the DUT may comprise an implantable pulse generator (IPG).

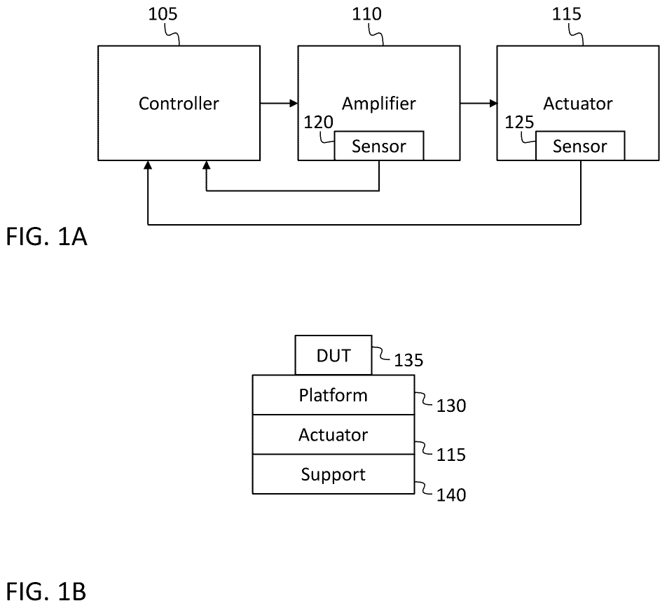

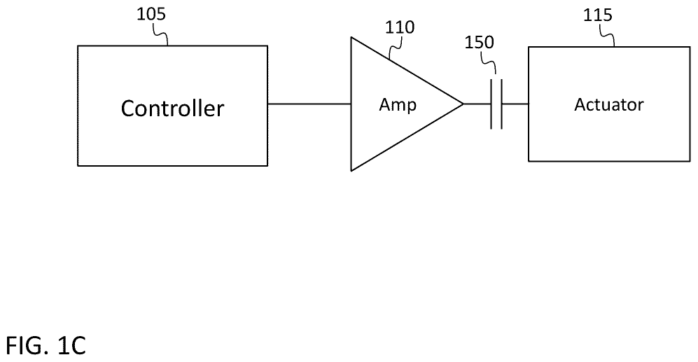

FIG. 1A is an electrical block diagram of a chest motion emulator, in some embodiments. A controller 105 (which may include a processing circuit) generates, at its output, an analog control signal which is transmitted to an amplifier 110 (e.g., a power amplifier, or “drive amplifier”), which generates a drive signal for an actuator 115. As such, the combination of the controller 105 and the amplifier 110 may be a drive circuit for the actuator 115. The amplifier 110 may include an amplifier sensor 120 for measuring an output quantity (e.g., an output voltage or an output current) of the amplifier 110. As used herein, a “sensor” may measure more than one quantity; for example, the amplifier sensor 120 may include a current sensor for measuring the output current of the amplifier 110 and a voltage sensor for measuring the output voltage of the amplifier 110. The actuator 115 may include, or be equipped with, an actuator sensor 125 which may be used to measure the motion (e.g., the (translational) position, velocity, or acceleration, or the angular position, velocity, or acceleration) of one or more points on the actuator (e.g., points on a platform 130 (FIG. 1B) for securing the device under test 135). The sensor or sensors of the actuator sensor 125 may include, for example, an accelerometer, a gyroscope, an optical sensor, a magnetic sensor, or a video camera for visual monitoring of the position or orientation of the platform 130 or of the device under test 135.

As mentioned above, a platform 130 may be part of, or secured to, the actuator 115, and may support or secure the device under test 135, as shown in FIG. 1B. The platform may be or include a mounting bracket, or a mounting plate, or one or more threaded fasteners (e.g., secured to a mounting bracket, or to a mounting plate, or directly to the actuator 115) or one or more through holes (e.g. in a mounting bracket, or in a mounting plate, or directly in the actuator 115), which may be used to attach (or “secure”) the device under test 135 to the actuator 115. In embodiments in which the actuator 115 is a loudspeaker (e.g., a subwoofer, as discussed in further detail below), the loudspeaker may have a cone with a flat region at the center of the cone. This flat region may be used as part of the platform. The device under test 135 may be secured to the flat region with threaded fasteners, each of which may extend through a mounting hole in the flat portion of the cone.

The controller 105 may be or include a computer or a microcontroller with an analog output. For example, the controller 105 may include a microcontroller including a digital to analog converter, or a general-purpose computer (e.g., a laptop computer) with an analog output (which may be the output, for example, of an integrated, direct-circuit coupled (DC-coupled), sound card, or which may be a Universal Serial Bus (USB) connected digital to analog converter that may have the same frequency range as the amplifier 110.

The analog control signal may include components corresponding to the heartbeat or respiration of a subject with which the device may be used. As such, it may be advantageous for the analog control signal to include frequency components ranging from the respiration rate (which may be as low as, e.g., 0.1 Hz) to the highest harmonic of interest of motion associated with the heartbeat, which may be, e.g., at 30 Hz. As such, the combination of the amplifier 110 and the actuator 115 may have a passband including at least a frequency range extending from 1 Hz to 5 Hz (e.g., a passband including a frequency range extending from 0.1 Hz to 5 Hz, or a passband including a frequency range extending from 0.1 Hz to 5 kHz). As used herein, a “passband” is a range of frequencies such that at all frequencies within the range the frequency response has a magnitude that is no less than the maximum magnitude of the frequency response, within the range, less 6 dB.

The amplifier 110 may be or include a DC-coupled amplifier (e.g., a DC-coupled class A amplifier, a DC-coupled class B amplifier, a DC-coupled class A/B amplifier, or a DC-coupled class D amplifier). In some embodiments, the amplifier 110 is not DC coupled, or is combined with a DC-blocking element, as discussed in further detail below. The amplifier 110 may be powered by a dual power supply and may have zero voltage bias at the output.

The actuator 115 may be an electrically-driven linear actuator, such as a voice coil actuator (e.g., a loudspeaker, such as a subwoofer, or (e.g., for emulating motion at higher frequencies, e.g., frequencies up to 5 kHz), a loudspeaker having a frequency response extending to higher frequencies than frequencies within the range of a subwoofer). As used herein, a “linear” actuator is an actuator that produces, as its (mechanical) output, translational motion (as opposed to rotary motion) in response to an electrical drive signal. As such, a linear actuator may be a linear motor (e.g., a voice coil actuator (as mentioned above), or an electromagnetic actuator with a geometry different from that of a voice coil actuator), or a rotary motor coupled to a suitable mechanism (e.g., a lead screw) for converting the rotational motion of the motor output shaft to translational motion.

The linear actuator may be a position actuator, such as a voice coil actuator. As used herein, a “position” actuator (as opposed to a velocity actuator) is an actuator that at low frequencies has a position proportional to the drive signal (unlike some actuators (e.g., a rotary motor coupled to a suitable mechanism for converting the rotational motion of the motor output shaft to translational motion) which may have a velocity proportional to the drive signal). As used herein, a voice coil actuator is an actuator including a cylindrical coil of wire in a gap of a cylindrically symmetrical magnet, the magnetic field in the gap being generally radial.

The controller 105 may be configured to cause (by supplying a suitable analog control signal to the amplifier 110) the actuator 115 to produce motion following a target motion profile. The target motion profile may represent the desired position, as a function of time, of the device under test 135. The target motion profile may be represented, e.g., by an array of values, each value of the array specifying a position at a corresponding point in time. The target motion profile may be selected to include a heartbeat signal, or a breathing signal, or a noise signal, each of which may be selected to emulate a corresponding motion component that may be expected to be present when a motion-sensing device is used with a live subject (e.g., to measure the heart rate or respiration rate of the subject). The noise signal may include a noise motion signal or other noise (e.g., wind noise or noise caused by motion of a subject's clothing against the device under test 135). The “noise motion signal” may include any subject motion that may be present (when the device under test 135 is used with a subject) in addition to the signal or signals (e.g., breathing and heartbeat signals) that the device under test 135 is designed to sense. As such, the noise motion signal may include non-breathing skeletal muscle motion (e.g., singultus, or motion corresponding to movements of the subject such as walking or running, or changes in position if a subject is seated or lying down) or digestive motion (motion associated with digestion). Other noise may include, e.g., wind noise or noise caused by motion of a subject's clothing against the device under test 135.

The target motion profile may be generated in any of several ways. For example, a subject (e.g., a volunteer) may be equipped with a motion sensor (e.g., strapped or otherwise secured to the chest of the subject) and the target motion profile may be recorded as the motion sensor senses the motion of the chest of the subject due to the subject's heartbeat and breathing, and due to other sources of motion such as subject motion or noise. This recorded signal may be saved in the controller 105 (e.g., stored in memory in, or connected to, or in communication with, the controller) and used as the target motion profile, for performing tests with the device under test 135. In some embodiments, such a recorded signal (or one or more similar heartbeat or breathing signals obtained otherwise, e.g., from a database of medical information, or from a computational model of human biomechanics (e.g. “OpenSim”)) may be modified to produce a target motion profile corresponding to an arbitrary heart rate or respiration rate, or a target motion profile with arbitrarily large or small noise components. As such, the system may be capable of producing motion that may be difficult to obtain from a live subject, e.g., motion corresponding to a heart rate that is sufficiently high to be hazardous to the subject.

In an embodiment in which the actuator 115 is a loudspeaker, the design of the voice coil may be one that can withstand a certain drive voltage at audio frequencies without overheating, in part because the back electromotive force (back EMF) produced by the motion of the voice coil within the magnet may limit the current flowing through the voice coil, and thereby limit the power dissipated in the voice coil, and in part because motion of the cone and the suspension of the loudspeaker may increase air flow over the voice coil. A DC voltage applied to the voice coil, however, may result in (i) no back EMF and a current limited only by the resistance of the voice coil and (ii) no increase in air flow over the voice coil. In such a situation the current may be sufficiently great to damage the voice coil. As such, as shown in FIG. 1C, the amplifier 110 (which may be a DC-coupled amplifier) may be connected to the actuator 115 through a capacitor 150, which may have a capacitance of within 50% of 0.2 F.

In other embodiments, overheating of (and damage to) the voice coil may be avoided by various other systems or methods. For example, the amplifier 110 may be coupled to the actuator 115 through a transformer (with a heat sink (or an active overtemperature protection circuit, which may use a temperature sensor on the transformer to limit or shut off the amplifier current as needed) to protect the transformer from overheating). In some embodiments, the temperature of the voice coil (or a value proportional to the temperature of the voice coil) is calculated by (i) squaring an output current sensed by the amplifier sensor 120 (to form a signal proportional to the power dissipated in the voice coil) and (ii) filtering the resulting signal with a filter (e.g. a lowpass filter) that models the thermal response of the voice coil. This calculated temperature signal may then be compared to a threshold, and the output current of the amplifier may be limited (e.g., shut off) when the calculated temperature signal exceeds the threshold.

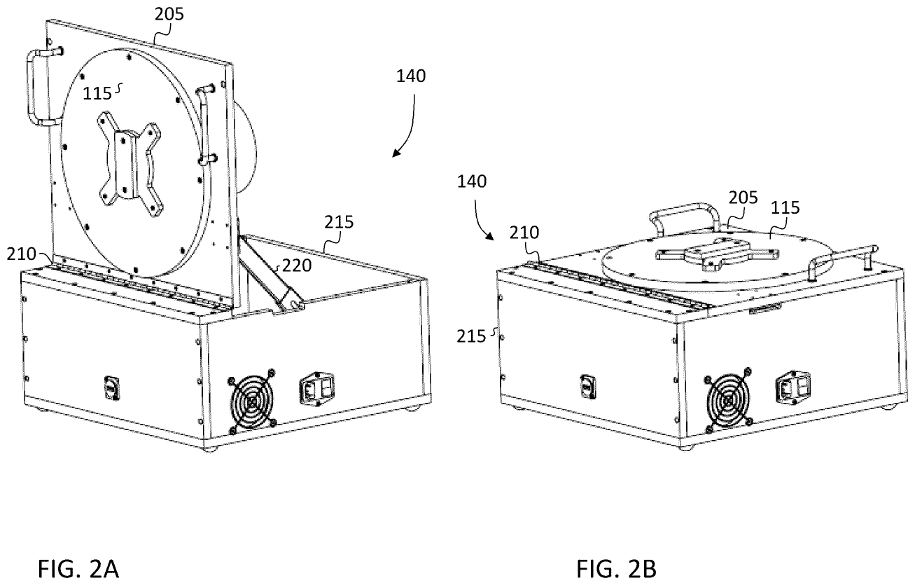

In some embodiments, the combination of the amplifier 110 and the actuator 115 provide sufficient range of motion to emulate both breathing and heartbeat. For example the range of motion may be between 0.25 inches and 3.0 inches, or more, e.g., at least 0.75 inches or at least 2.0 inches. In some embodiments, the actuator 115 is secured to a support 140, which may be used to provide stable support for the actuator, e.g., on a desk or lab bench. FIGS. 2A and 2B show an example of such a support 140, which may include an actuator plate 205 to which the actuator 115 is secured. The actuator plate 205 is attached through a hinge 210 to an enclosure 215. One or more braces 220 support the actuator plate 205 when the actuator 115 is in the horizontal position (in the position in which the direction of motion of the actuator is horizontal). FIG. 2B shows the embodiment of FIG. 2A with the actuator 115 in a vertical position (in the position in which the direction of motion of the actuator is vertical). Each of the braces 220 (of which there may be two, only one of which is visible in FIG. 2A) may be an extendable brace, e.g., a flat telescoping strut capable of being (i) locked in an extended position, to support the actuator 115 in the horizontal position or (ii) released to return to a retracted position, in which the actuator plate 205 is supported by the walls of the enclosure 215 and the actuator 115 is in the vertical position. Such an arrangement may also enable the operation of the actuator 115 in intermediate positions, between the horizontal position and the vertical position.

Various systems and methods may be employed to calibrate the system, e.g., to ensure that the motion, of the device under test 135, produced by the actuator 115, is substantially equal to the target motion profile. For example, the displacement of the actuator 115 may be measured (using a suitable sensor or measuring instrument) while the output current of the amplifier 110 is known (e.g., as a result of also being measured using a suitable sensor or measuring instrument), and the ratio of displacement to drive current may be used to scale the target motion profile. For example, in operation (after calibration has been completed) the target motion profile may be divided by the ratio of displacement to drive current (calculated from the measured displacement and the measured drive current) and the result of this division may be fed to the amplifier 110. The division may be performed digitally, before the signal is converted to analog form by the digital to analog converter. Such a method may provide sufficient accuracy if the frequency response of the combination of the amplifier 110 and the actuator 115 is sufficiently flat over the range of frequencies of interest.

In some embodiments, a frequency-dependent calibration is used, e.g., the transfer function of the combination of the amplifier 110 and the actuator 115 is measured and an inverse filter (which may be a digital discrete-time filter, e.g., an infinite impulse response (IIR) filter or a finite impulse response (FIR) filter) may be created (e.g., by fitting the filter coefficients so that the filter frequency response is approximately equal to the inverse of the measured transfer function). This filter may then be applied, e.g., in the controller 105, before the signal is converted to analog form by the digital to analog converter. Such an approach may be used to suppress the effects, for example, of a DC blocking circuit (such as the capacitor 150 of FIG. 1C) or of a resonance of the actuator 115 (e.g., in the case of an actuator that is a loudspeaker, the resonance due to (i) the moving mass of the actuator, including the mass of the device under test 135, and (ii) the restoring force of the suspension of the loudspeaker).

In some embodiments, closed-loop control of the amplifier output current or of the position (or velocity, or acceleration) of the actuator may be used to reduce discrepancies between the target motion profile and the motion of the actuator. For example, an error signal may be calculated (i) by subtracting the measured motion of the actuator from the target motion profile, or (ii) by subtracting the measured amplifier output current from an amplifier current that is calculated based on the target motion profile. Either or both of these error signals may then be fed back to the controller 105 (as shown in FIG. 1A) or to the input of the amplifier 110 (and added to the signal, after filtering with a loop filter or scaling with a suitable gain).

In some embodiments, a plurality of actuators (each driven by a respective amplifier) may be combined, e.g., to cause motion of the device under test 135 in several degrees of freedom. For example, a second actuator may be secured to a platform of a first actuator, and the device under test 135 may be secured to a platform of the second actuator. In such an embodiment, if the direction of motion of the second actuator is perpendicular to the direction of motion of the first actuator, driving both actuators may result in motion, of the device under test 135, along both directions, i.e., along the two translational degrees of freedom corresponding to the directions of motion of the actuators. In other embodiments, one or more linkages, hinges, or flexures may be used to combine the motions produced by several actuators. For example, in some embodiments, the actuators are arranged in a Stewart platform (or “hexapod”) configuration and are able to produce motion, of the device under test 135, in each of its three translational degrees of freedom and in each of its three rotational degrees of freedom. In an embodiment with a plurality of actuators the position of the device under test 135 may be specified as a 6-element vector, and the target motion profile may similarly include the six degrees of freedom (3 translational degrees of freedom and 3 rotational degrees of freedom) of a rigid-body.

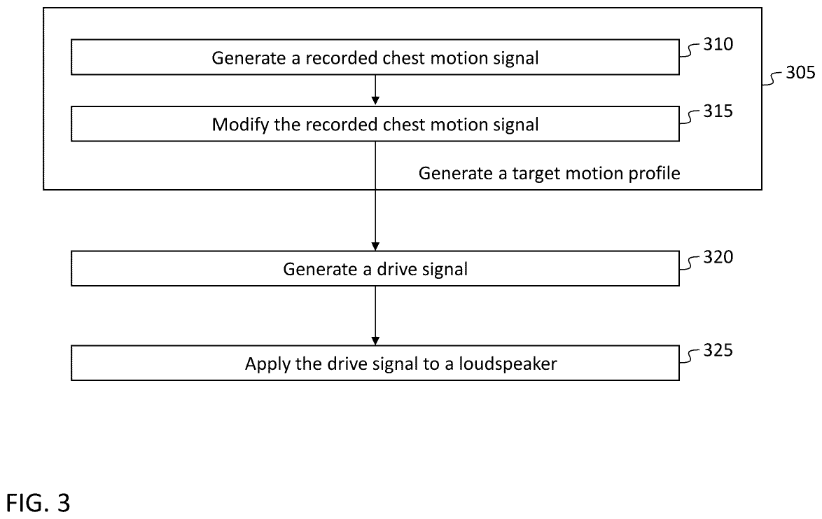

FIG. 3 is a flow chart of a method for operating a chest motion emulator including a loudspeaker, in some embodiments. The method includes generating, at 305, a target motion profile. The target motion profile may be generated as discussed above; for example, the generating of the target motion profile may include generating, at 310, a recorded chest motion signal (e.g., recording, as discussed above, a signal from a motion sensor secured to the chest of a subject), and modifying, at 315, the recorded chest motion signal (or the generating of the target motion profile may include generating (using a computational model of human biomechanics) a simulated chest motion signal, and optionally modifying the simulated chest motion signal). The modifying may include, as discussed above, modifying the recorded chest motion signal to generate a motion signal corresponding to a heart rate that is higher or lower than the heart rate of the subject was when the recording was generated.

The method may further include generating a drive signal, at 320. This drive signal may be generated, for example, by converting the target motion profile to analog form, and amplifying the resulting analog signal, as discussed above. The method may further include applying the drive signal to the loudspeaker, at 325. As discussed above, the loudspeaker may be configured to support or secure a device under test 135, so that the chest motion emulator may be used to test or characterize the response of the device under test 135 to the motion generated by the chest motion emulator.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y%” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Although not clearly depicted in the figures, in some implementations the system may include one or more heat dissipation components, such as a heat sink or a fan, to help regulate the temperature of (e.g., to cool) electrical components within the chest emulator, such as the amplifier 110, or heat-dissipating components of the amplifier 110, such as output transistors of the amplifier 110. In such instances, some embodiments may include one or more heat sinks (and may not include any fans) for cooling to avoid the possibility that fan motion is detectable by the motion sensor of the DUT and could unintentionally skew testing results.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1- 35/100) times 10) and the recited maximum value of 13.5 (i.e., (1+ 35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although exemplary embodiments of a chest motion emulator have been specifically described and illustrated herein, many modifications and variations will be apparent to those skilled in the art. Accordingly, it is to be understood that a chest motion emulator constructed according to principles of this disclosure may be embodied other than as specifically described herein. The invention is also defined in the following claims, and equivalents thereof.

What is claimed is:

1. A system comprising:
a chest motion emulator, comprising:
a first linear actuator,
the first linear actuator being configured to support a device under test.

2. The system of claim 1, wherein the first linear actuator comprises a voice coil actuator.

3. The system of claim 2, wherein the first linear actuator comprises a loudspeaker.

4. The system of claim 3, wherein the loudspeaker comprises a cone comprising a mounting hole for securing the device under test.

5. The system of claim 1, wherein the chest motion emulator further comprises a drive amplifier connected to the first linear actuator.

6. The system of claim 5, wherein the drive amplifier is DC-coupled.

7. The system of claim 5, wherein the drive amplifier is a class D amplifier.

8. The system of claim 5, wherein the combination of the drive amplifier and the first linear actuator has a passband including a frequency range extending from 1 Hz to 5 Hz.

9. The system of claim 5, wherein the combination of the drive amplifier and the first linear actuator has a passband including a frequency range extending from 0.1 Hz to 5 Hz.

10. The system of claim 1, further comprising a second linear actuator, wherein the first linear actuator and the second linear actuator are configured to produce motion, of the device under test, in a first degree of freedom and in a second degree of freedom.

11. The system of claim 10, wherein the first degree of freedom is a first translational degree of freedom and the second degree of freedom is a second translational degree of freedom, different from the first translational degree of freedom.

12. The system of claim 10, wherein the first degree of freedom is a translational degree of freedom and the second degree of freedom is a rotational degree of freedom.

13. The system of claim 1, wherein:
the chest motion emulator is capable of emulating chest motion of a subject, and
the chest motion comprises motion caused by breathing.

14. The system of claim 13, wherein the chest motion further comprises motion caused by a heartbeat.

15. The system of claim 13, wherein the chest motion further comprises noise motion.

16. The system of claim 15, wherein the noise motion comprises non-breathing skeletal muscle motion.

17. The system of claim 15, wherein the noise motion comprises digestive motion.

18. The system of claim 1, wherein the device under test is an implantable pulse generator.

19. A system comprising:
a first loudspeaker; and
a drive circuit,
the drive circuit being configured to cause the first loudspeaker to move in a manner emulating chest motion of a subject.

20. A method, comprising:
generating emulated motion, by a chest motion emulator, the emulated motion emulating chest motion of a subject,
the chest motion emulator comprising:
a loudspeaker; and
a drive circuit.

21. The method of claim 20, wherein the chest motion comprises motion caused by breathing.

22. The method of claim 20, wherein the chest motion further comprises motion caused by a heartbeat.

23. The method of claim 20, wherein the chest motion further comprises noise motion.

24. The method of claim 23, wherein the noise motion comprises non-breathing skeletal muscle motion.

25. The method of claim 23, wherein the noise motion comprises digestive motion.

26. The method of claim 20, wherein the generating of the motion comprises:
generating a target motion profile;
generating a drive signal based on the target motion profile; and
applying the drive signal to the loudspeaker.

27. The method of claim 26, wherein the generating of the target motion profile comprises:
generating a recorded chest motion signal by recording a signal from a motion sensor secured to the chest of a subject; and
modifying the recorded chest motion signal.
